(19) United States
(12) Patent Application Publication
(10) Pub. No.: US 2012/0102505 A1
(43) Pub. Date: Apr. 26, 2012

(54) DYNAMIC PROCESS VIRTUALIZATION

(75) Inventors: Jeremy Dunker, Boston, MA (US); Neil Jacobson, Acton, MA (US); Kristofer Reierson, Acton, MA (US)

(73) Assignee: MICROSOFT CORPORATION, Redmond, WA (US)

(21) Appl. No.: 12/911,577

(22) Filed: Oct. 25, 2010

(51) Int. Cl. G06F 9/44

(52) U.S. Cl. 719/318

(57) ABSTRACT

Access to virtual application resources can be regulated at runtime. More specifically, a process can be provided with access to at least one virtual application resource as a function of context. By way of example, process events can be monitored and analyzed during execution to determine whether access should be provided to the process.

### BACKGROUND

Application virtualization is a collection of technologies that enable software applications to be decoupled from an operating system. Rather than being installed directly to a computer in the traditional sense, a virtualized application is deployed on the computer as a service. Nevertheless, the virtualized application executes as if it were installed on a computer. The application is in some sense fooled into believing it is installed and interfacing directly with a computer operating system. This can be accomplished by encapsulating the application in a virtual environment or virtualization layer that intercepts file and other operations of the application and redirects the operations to a virtualized location.

There are several benefits of application virtualization. In particular, applications are isolated from each other and an executing computer at least to a degree by way of a virtual environment. Accordingly, multiple applications can be run at the same time including otherwise incompatible or conflicting applications. In addition, applications can be run in environments other than that for which an application was designed. Further, isolation protects other applications and an underlying operating system from poorly written or faulty code. Similarly, security can be improved by isolating applications from an operating system.

A virtualization application includes a number of parts. The first part is the package file where application assets or resources reside. This package contains data and metadata necessary to run the application on a computer. These resources include but are not limited to files and a directory structure. At runtime, a virtual application comprises these resources, or namespaces, running on the computer. Through virtualization, resource namespaces and native namespaces can be stitched together so that the application can find its resources.

Whether a process, or instance of an application being executed, is virtual can be determined as a function of a parent process. More specifically, if the parent process is virtual then the child process inherits the virtuality. Here, being virtual or virtualized means that the process has access to application resources. For example, a word-processing application needs to find files necessary for its functioning. Application virtualization can redirect file requests such that the application locates its resources.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to dynamic process virtualization. Access to virtual application resources can be regulated as a function of context at runtime. For example, a process can be virtualized, or in other words provided access to virtual resources, during execution based on process events such as application programming interface (API) calls. Similarly, a process can be transitioned from a first to a second virtual environment or removed from a virtual environment altogether based on context. Among other things, delaying decisions regarding process virtualization until runtime enlarges the scope of application virtualization, and consequently enables virtualization scenarios that were previously unavailable.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram that facilitates application virtualization.

FIG. 2 is a block diagram of a representative determination component.

FIG. 3 is a block diagram of a representative analysis component.

FIG. 4 is a block diagram of a representative access component.

FIG. 5 is a flow chart diagram of a method of facilitating application virtualization.

FIG. 6 is a flow chart diagram of a method of facilitating application virtualization.

FIG. 7 is a flow chart diagram of a method of process virtualization.

FIG. 8 is a sequence diagram that illustrates an exemplary use case.

FIG. 9 is a schematic block diagram illustrating a suitable operating environment for aspects of the subject disclosure.

### DETAILED DESCRIPTION

Details below are generally directed toward dynamic process virtualization, or in other words, provisioning access to virtual application resources at runtime. Conventional application virtualization technology utilizes a parent process or other factors to determine whether a process is virtual at process creation time, wherein being virtual means the process has access to resources of a virtualized application. The assumption that a process can be identified as requiring access to virtual resources at process creation time, for example by examining a parent process, simplifies many aspects of virtualization, but imposes some limitations. For example, due to the way some software is implemented, it is not always feasible to add a process to a virtual environment at process creation time, because information is not available to determine to which virtual environment the process belongs. Furthermore, not all instances of a process need to be virtualized, and since there can be more than one virtual application on a system one cannot be sure to which virtual application an instance of a process should be attached.

To address at least the aforementioned issues, decisions regarding virtualization can be delayed until runtime as opposed to being confined to process creation time. Consequently, the scope of virtualization is enlarged thereby enabling virtualization scenarios that were previously unavailable, such as, but not limited to, virtualization of operating system processes that host application specific code. Further, decisions regarding virtualization can be made as a function of context information including process events. Still further yet, various mechanisms can be employed to carry out process virtualization decisions.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

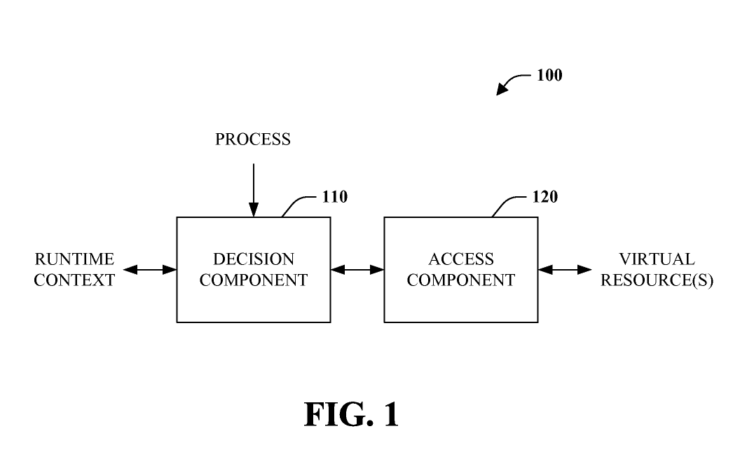

Referring initially to FIG. 1, a system 100 that facilitates application virtualization is illustrated. The system 100 includes a decision component 110 and an access component 120. The decision component 110 is configured to receive, retrieve, or otherwise identify a process, or other unit of computation, and make a decision regarding virtualization of the process. Moreover, the decision component 110 is configured to operate at runtime, or in other words during process execution. Additionally, a decision can be made by the decision component 110 as a function of context such as, but not limited to, process events. The access component 120 is configured to provide a process access to particular virtual application resources, among other things. For instance, upon a decision that a process is to be virtualized by the decision component 110, the access component 120 can make the process virtual or more generally provide the process with access to virtual application resources.

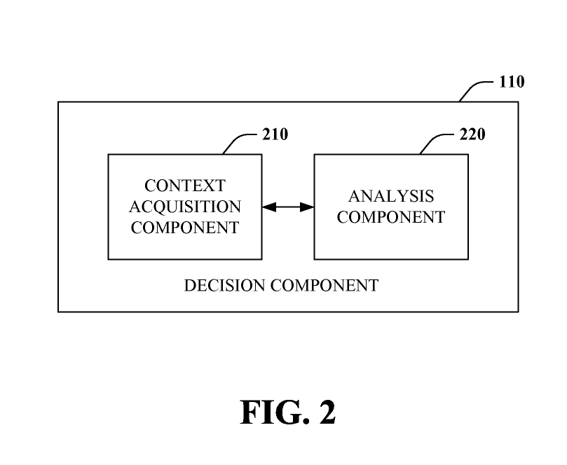

FIG. 2 illustrates a representative decision component 110 in further detail. The decision component 110 includes a context acquisition component 210 and an analysis component 220. The context acquisition component 210 can receive or retrieve context information that can aid the analysis component 220. In accordance with one embodiment, the context acquisition component 210 can monitor and capture one or more process events or a stream of process events. By way of example, and not limitation, the context acquisition component 210 can intercept one or more application programming interface (API) calls of a process. In addition, the context acquisition component can receive or retrieve context information outside the process. In one non-limiting example, the context can be requested and received from a local or remote service. The analysis component 220 is configured to analyze information obtained by the context acquisition component 210 in order to make a decision regarding virtualization of a process, or more particularly an instance of a process. For instance, the analysis component 220 can determine whether particular conditions or criteria are met for dynamic virtualization of a process.

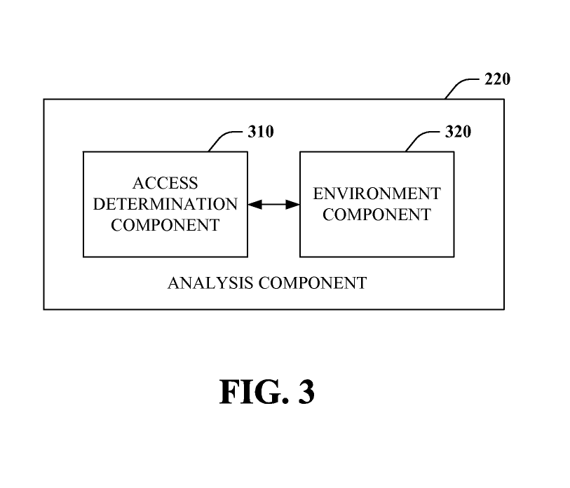

Turning attention to FIG. 3, a representative analysis component 220 is depicted in further detail. As shown, the analysis component 220 is broken up into two sub-components, namely access determination component 310 and environment component 320. The access determination component 310 is configured to include logic that is employed to determine whether any action should be taken with respect to a process as well as a type of action as a function of context, for example. The environment component 320 can utilize similar information as the access determination component 310 to identify at least one environment in which an action will occur. In one embodiment, the access determination component 310 can determine that a process should be virtualized and the environment component 320 can identify a particular environment to which the process should be virtualized, amongst a plurality of environments, for instance. Stated differently, the access determination component 310 determines that a process should be given access to virtual application resources and the environment component 320 identifies the particular virtual application resources. Subsequently, the process can be transitioned to the virtual environment, for instance.

Furthermore, the analysis component 220 is not limited to make determinations as to whether a process should be virtualized. Decisions can also be made as to whether to make a virtualized process native (e.g., move out of a virtual environment) or whether to a virtual process should be moved to a different virtual environment. For example, if, based on context, it can be determined that a virtual environment is being taken down or crashing (e.g., sudden failure) and it is desirable that a virtual process not terminate, then it can be decided that the process be moved outside the virtual environment. There are some system processes, for instance, that cannot terminate without causing the underlying operating system to fail. However, if such processes are virtualized, being able to remove them from the virtual environment is beneficial in avoiding this result. As per moving virtual processes amongst virtual environments, if a service does lifetime monitoring of an application and the service can only interact with resources while the service is in the virtual environment, then it can be beneficial to move such a service from one virtual environment to another.

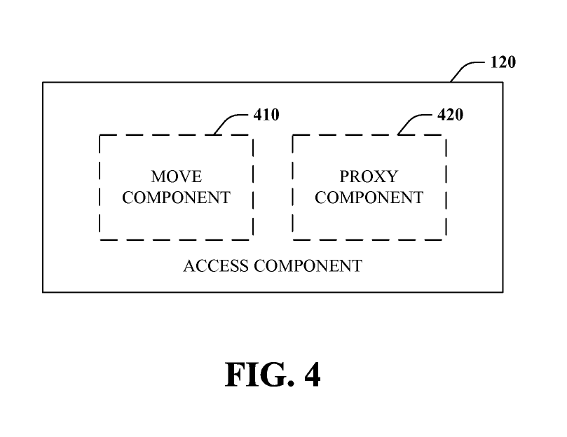

FIG. 4 depicts a representative access component 120 configured to provide access to one or more environments including but not limited to a virtual environment. The access component 120 can be implemented in at least two manners represented by a move component 410 and proxy component 420.

The move component 410 is configured to transition a process from a first execution environment to a second execution environment. In one instance, the move component can transition a native process (e.g., locally installed and executable on top of a particular operating system) to a virtual process (e.g., locally deployed as software as a service (SaaS) and executable in an environment independent of a particular operating system), for example by augmenting the process to enable interaction in the virtual environment (e.g., hooking). Similarly, the move component 410 can augment a process to enable a virtual process to operate outside a virtual environment or in a different virtual environment.

The proxy component 420 can provide similar functionality as the move component 410 but in a different way. In particular, proxy component 420 provides an intermediary computer system or program between a process and a virtual environment. The proxy component 420 can thus receive requests for virtual resources from a process, interact with the virtual environment as requested, and return any results to the process. For example, rather than transitioning a process to a virtual process to enable access to virtual application resources, a proxy can be employed to provide a non-virtual process access to virtual application resources. Moreover, there is no need to move or transition a process back to a native environment (e.g., operating system dependent, host environment) if desired. Rather, a corresponding proxy can simply be removed or otherwise disengaged from use by the process. Likewise, different proxies can be employed to enable a process to be utilized across distinct virtual environments as opposed to moving a process from a first to a second virtual environment. Still further yet, instead of deciding whether to move a process, the decision concerns whether to interact with a proxy.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the decision component 110 can employ such mechanisms concerning provisioning access to virtual application resources. For instance, the decision component 110 can be configured to determine or infer whether a process should be virtualized as a function of context.

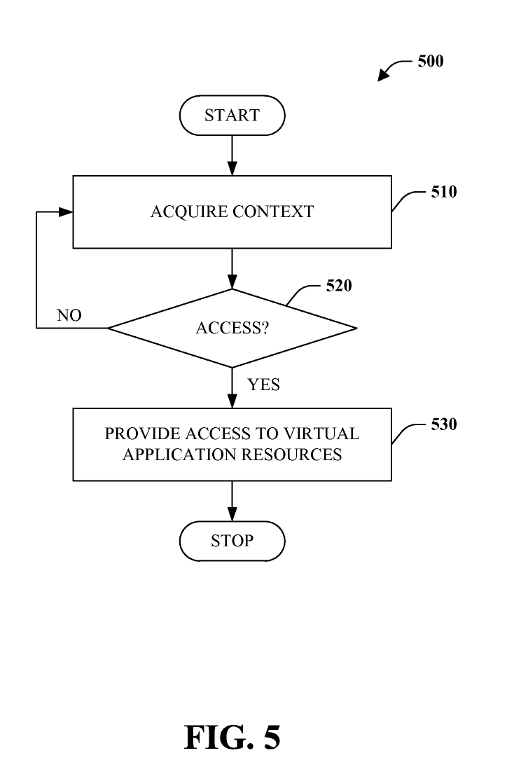

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method 500 of facilitating application virtualization is illustrated. At reference numeral 510, context is received, retrieved, or otherwise obtained or acquired, for example by monitoring one or more sources of context. In one instance, one or more process events can be observed. For example, application programming interface (API) calls can be intercepted. At 520, a determination is made as to whether a process should be virtualized, or in other words, whether the process should have access to virtual application resources. The determination can be based on a myriad of factors. For example, a predetermined set of circumstances may need to occur before access is granted. In the scenario in which process events are intercepted, for example, the determination can be based on a virtualization criteria specified in terms of the occurrence of one or more events. If, at 520, access is not granted (“NO”), for example because a set of circumstance have not been satisfied, the method 500 can loop back to reference numeral 510, wherein additional context can be acquired. If it is determined that a process should have access at 520 (“YES”), the method 500 continues at 530 where the process is virtualized or stated differently access is provided to virtual application resources. Furthermore, it is to be appreciated that part of the access determination at 520 and/or provisioning of access at 530 can include identifying a particular virtual environment for which access is provided. For example, where multiple virtual applications or environments exist, access should be provided to the appropriate environment (e.g., with respect to a virtualized application with which the process interacts (e.g. reads or writes data)). Still further yet, note that the method 500 can also apply to determining whether a virtual process can be virtualized in, or access, a different environment.

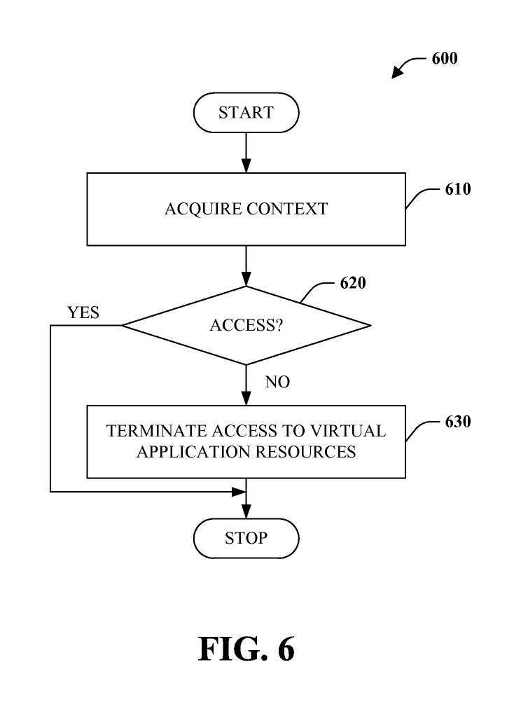

FIG. 6 is a flow chart diagram of a method 600 of facilitating application virtualization. At reference numeral 610, context can be received, retrieved, or otherwise obtained or acquired. For example, such context can concern the stability and/or expected state of a virtual environment. At numeral 620, a determination is made as to whether a process should remain virtual, or stated differently whether a process should continue to have access to virtual resources. If it is determined, at 620, that access should continue (“YES”), the method 600 terminates. Alternatively, if it is determined that access should not continue (“NO”) then the method 600 continues at reference 630, wherein access to virtual application resources is terminated for a process. The method 600 can thus enable a virtual process, or a process with access to virtual resources, to be converted to a non-virtual process, or in other words, have access to virtual resources terminated. For example, where an operating system process is virtualized and it can be determined or inferred based on context that a virtual environment is about to terminate (e.g., sudden failure), the process can be removed from the virtual environment to prevent termination of the process and possible operating system instability.

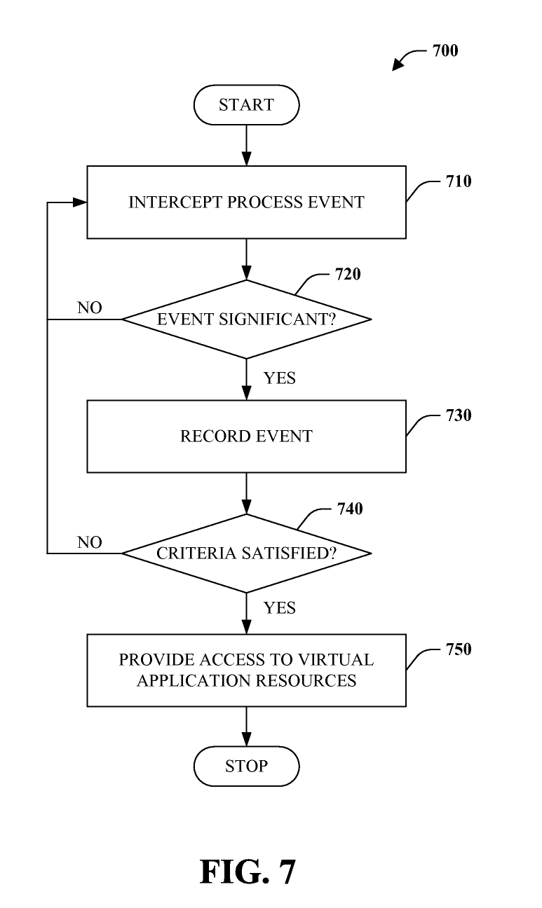

FIG. 7 depicts a method 700 of process virtualization. At reference numeral 710, a process event is intercepted such as but not limited to an application programming interface (API) call or like calls. At 720, the event is analyzed to determine whether the intercepted process event is significant, wherein significance relates to any information that may be useful in determining whether to virtualize a process. In addition to a call itself, for example, parameters of a call can also be inspected to determine if an event is significant. If an event is insignificant (“NO”), the method 700 loops back to reference numeral 710 where additional process events can be intercepted. If an event is deemed significant (“YES”), the method 700 continues at 730 where the event is recorded or saved to a computer-readable storage medium. At reference numeral 740, a determination can be made as to whether virtualization criteria have been satisfied. Such criteria can specify interaction with virtual resources, for example. Further, such criteria can be specified in terms of one or more process events and as such arbitrarily complex runtime decisions can be employed with respect to process virtualization. Still further, the determination at reference numeral 740 can be made with respect to one or more process events recorded at 730. If virtualization criteria are not satisfied (“NO”), the method 700 returns to reference numeral 710 where additional process events can be intercepted. If, however, virtualization criteria are satisfied (“YES”), the method 700 proceeds to numeral 750 where the process is virtualized, or in other words, access is provided to virtual application resources (e.g., via proxy).

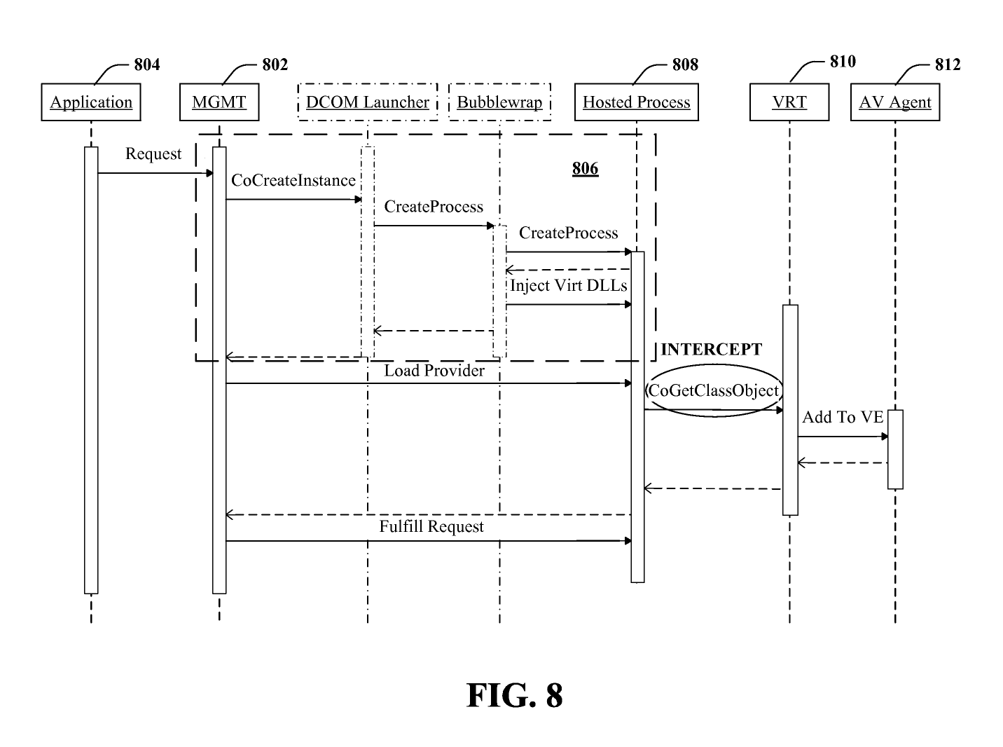

FIG. 8 is a sequence diagram that illustrates one exemplary use case associated with aspects of the claimed subject matter. The sequence diagram concerns employment of analysis services or more particularly managed instrumentation. Here, components can be instrumented as managed entities by modeling computational entities or objects, such as an application, as a class within a provider. Subsequently, the managed entity can be controlled by sending messages thereto. For example, interactions with the managed entity can relate to entity configuration, monitoring, diagnostics, and task automation, among other things.

As shown, management component (MGMT) 802 can be an operating system service that manages provider objects. When a request comes in from a client such as an application 804 (e.g., on a local or remote machine) to perform some action on a provider, the management component 802 can call “CoCreateInstance” which will initiate a series of other operating system actions 806 that produce a hosted process 808 (e.g., native process). Once the hosted process is established, the management component 802 can send an additional command to load a specific provider. Once the provider is loaded, the application 804 can interact with the provider process to fulfill its initial request as well as to submit additional requests.

When the management component 802 instructs the hosted process 808 to load a specific provider, a determination can be made whether or not to virtualize the provider. More specifically, the virtual runtime component (VRT) 810 can intercept a call to “coGetClassObject” and inspect the call parameters to determine if the hosted process 808 should be virtualized and if so to which virtual environment the hosted process 808 should be moved. If it is decided that the hosted process 808 should be virtualized then the application virtualization agent (AV Agent) 812 can transition the process to the virtual environment, for example by enabling hooks in the process for virtualization. The original “CoGetClassObject” call can then be returned to the management component 802. From this point, interaction with a provider is just like any other provider, except that the provider has been moved into a virtual environment, and it can now access virtual resources.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The term “native” as used herein with respect to application, process or other unit of execution is intended to refer broadly to a locally installed executable running on top of a particular operating system of a computer. As used with respect to an environment, “native” refers to the software platform of a computer system that supports locally installed executables. The word “native” is thus intended to contrast with “virtual,” wherein executables are deployed rather than installed in an environment that does not directly interface with an operating system of a machine.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

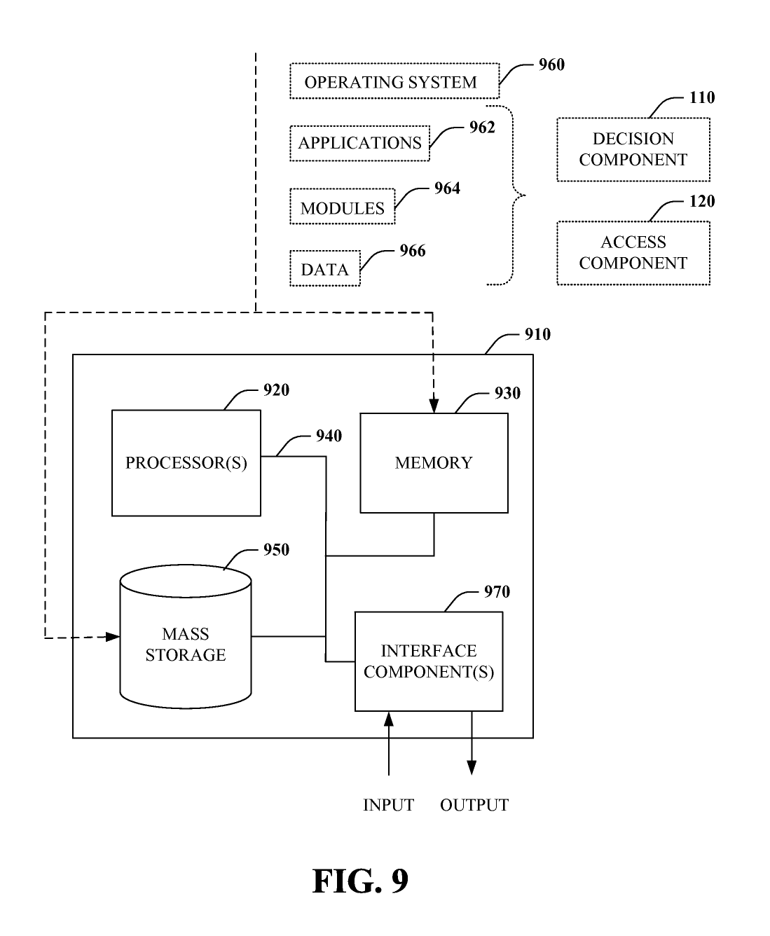

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, server, hand-held, programmable consumer or industrial electronics, set-top box, game system . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 910.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the decision component 110 and the access component 120 can be, or form part, of an application 962, and include one or more modules 964 and data 966 stored in memory and/or mass storage 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the decision component 110, access component 120, and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910 through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating application virtualization, comprising:
employing at least one processor configured to execute computer-executable instructions stored in memory to perform the following acts:
regulating access of a process to one or more virtual application resources at runtime as a function context.

2. The method of claim 1 further comprises adding the process to a virtual environment.

3. The method of claim 1 further comprises removing the process from a virtual environment.

4. The method of claim 1 further comprises moving the process from a first virtual environment to a second virtual environment.

5. The method of claim 1 further comprises regulating interaction with a proxy that enables access to the one or more virtual application resources.

6. The method of claim 1 further comprises monitoring one or more process events.

7. The method of claim 6 further comprises monitoring one or more operating system process events.

8. The method of claim 6 wherein monitoring comprises intercepting one or more application programming interface (API) calls by the process.

9. A system that facilitates application virtualization, comprising:
a processor coupled to a memory, the processor configured to execute the following computer-executable components stored in the memory:
a first component configured to provide a native-environment process access to one or more virtual-application resources at runtime.

10. The system of claim 9 further comprising a second component configured to control access as a function of context.

11. The system of claim 10 further comprising a third component configured to monitor one or more events of the process.

12. The system of claim 11 wherein the third component is configured to intercept one or more application programming interface (API) calls and inspect call parameters.

13. The system of claim 11 further comprising a fourth component configured to identify a virtual environment as a function of the one or more events of the process.

14. The system of claim 13 the first component is configured to transition the process from a native environment to the virtual environment.

15. The system of claim 9 the process is configured as a provider process that models a computational entity to enable collection of information from the entity.

16. The system of claim 15 the one or more virtual-application resources are virtual server-application resources.

17. A computer-readable storage medium having instructions stored thereon that enables at least one processor to perform the following acts:
transitioning a process from a native environment to a virtual environment at runtime based upon occurrence of one or more process events.

18. The computer-readable storage medium of claim 17 further comprises transitioning the process as a function of information acquired from outside the process.

19. The computer-readable storage medium of claim 17 further identifying the virtual environment from a plurality of virtual environments as a function of one or more virtual application resources and the one or more process events.

20. The computer-readable storage medium of claim 17 further comprises monitoring a stream of process events for the one or more process events.
